(19) United States
(12) Patent Application Publication
(10) Pub. No.: US 2004/0064074 A1
(43) Pub. Date: Apr. 1, 2004

(54) Massage device

(76) Inventors: Melvin R. Kennedy, Lantana, FL (US); Jose Longoria, Miami, FL (US); Robert G. Robbins, Boca Raton, FL (US); Steve Chininis, Norcross, GA (US)

Correspondence Address: AKERMAN SENTERFITT, P.O. BOX 3188, WEST PALM BEACH, FL, 33402-3188, US

(21) Appl. No.: 10/635,630

(22) Filed: Aug. 6, 2003

Related U.S. Application Data
(60) Provisional application No. 60/415,314, filed on Sep. 30, 2002.

(51) Int. Cl. A61H 9/00; A61H 23/04

(52) U.S. Cl. 601/55; 601/110; 601/111; 601/155; 601/160; 601/169

(57) ABSTRACT

A massage device for creating a massaging action using at least one oscillating device. The massage device may be formed from a handle and a head pivotably coupled to the handle. The head may include a first chamber for containing the oscillating device and a second chamber for containing an impeller for driving the oscillating device. The oscillating device may be fluid driven. The massaging device may also include one or more controls in the handle for controlling the action of the massage device.

### CROSS-REFERENCE TO RELATED APPLICATIONS

This application claims the benefit of U.S. Provisional Application No. 60/415,314, filed Sep. 30, 2002.

### FIELD OF THE INVENTION

This invention is directed to a massage device and, more particularly, to an oscillator driven massage device.

### BACKGROUND

Numerous handheld electrically powered percussion massagers exist for providing massaging action. These percussion massagers are typically designed for single-handed operation and have one or more massage heads protruding from the device. The massage heads typically move in an up-and-down or orbital motion, which creates a massaging action. Various mechanicals assemblies have been developed by which the massage heads can move to vary the speed and force delivered by the massaging action.

Some of the massagers are operable as massaging showerheads. Massaging showerheads are often supported by brackets attached to shower walls so that the showerheads may be used as stationary showerheads or may be removed from the brackets and used as handheld massaging devices. Water massage showerheads often alter the direction and pressure of the water emitted from the shower head to create different massaging actions.

While a massaging showerhead may provide a soothing massaging action, such a massaging action lacks the amount of force typically delivered by electrically powered massagers. Furthermore, massagers not driven by water often do not provide the warmth and comfort available from a flow of warm water emitted from a massaging showerhead. Thus, there exists a need for a massager having these and other advantages.

### SUMMARY OF THE INVENTION

This invention is directed to a massage device for providing a massaging action for a human or an animal. In at least one embodiment, the massage device may be a handheld water driven device. The handheld device may be formed in part from a handle and a head pivotably coupled to the handle. One or more massage heads may be coupled to the head for translating the massaging action created by the massage device to a person or animal.

The massage device may include an oscillation device for creating a pulsating action. In at least one embodiment, the oscillation device may be contained in the handle of the massage device. The oscillation device may be configured to produce one or a plurality of massaging actions. The oscillation device may be water driven using one or more impellers. In at least one embodiment, at least one of the impellers may be positioned generally parallel to a longitudinal axis of the massage device. In other embodiments, at least one of the impellers may be positioned generally orthogonal to the longitudinal axis of the massage device. In embodiments of the massage device where the oscillation device is water driven, a nozzle, or other conduit outlet, may be placed in close proximity to the impeller and positioned so that fluids emitted from the nozzle may rotate the impeller and, in turn, drive the oscillation device. The fluids may be, but are not limited to, water, gas hot oils, and other appropriate materials. In water driven embodiments of the massage device, water used to drive the massage device may be expelled through one or more orifices in the head proximate to the massage heads to augment the massaging action of the massage head in the vicinity of the area receiving the massaging action.

The impeller may be formed from at least two sections, whereby a first section is configured to catch a fluid jet and rotate the impeller in a first direction, and a second section is configured to catch a fluid jet and rotate the impeller in a second direction that is generally opposite to the first direction. Rotating the impeller in opposite directions may create different oscillatory actions created by the oscillation device. Each section of the impeller may have a different diameter, which may produce a different rotational speed of the impeller using the same fluid jet. Thus, an impeller having one or more sections with different sizes may produce different rotational speeds of a shaft to which the impeller may be attached.

In at least one embodiment, the oscillation device of the massage device may be formed from at least one gear having a weight pivotably coupled to the gear. The weight may be pivotably coupled to the gear along a rotational axis that is different from the rotational axis of the gear. Thus, the center of mass of the weight may not be at the rotational axis of the gear. The gear may include one or more stops for positioning the weight in at least two positions, a first and second position. Often the weight may be in a first position when the gear is rotated in a first direction, and the weight may be moved to a second position when the gear is rotated in a second direction that is generally opposite to the first direction. In at least some embodiments, the distance between the center of mass of the weight in the first position and the rotational axis of the gear is different than the distance between the center of mass of the weight in the second position and the rotational axis of the gear. This configuration may produce different massaging actions depending on which direction the gear is rotated because the center of mass is at a different distance from the rotational axis. Thus, different amounts of radial forces may be produced.

In some embodiments, the oscillating device may include two drive gears coupled together with a center gear so that the two drive gears rotate in the same direction. Each drive gear may include a weight rotatably connected to the drive gear. In at least one embodiment, one weight may be fixedly attached to a first drive gear and another weight may be rotatably attached to the second drive gear.

In an exemplary embodiment, the oscillating device may be formed from at least two drive gears and a center gear positioned between the two drive gears. Each of the drive gears may include a weight pivotably coupled to the drive gear at an axis that is different from the rotational axis of the drive gear. The center of mass of the weights may be at different distances from the rotational axes of the drive gears. Each gear may include a stop for positioning the weights in either a first or second position. The second position may position the weight about 180 degrees from the first position. In some embodiments, the weight may travel about 185-200 degrees from the first position to the second position to keep the weight from inadvertently returning the to first position while the drive gear is being rotated in a direction in which the weight should be in the second position.

The impeller may be coupled to one of the drive gears or the center gear. When a fluid jet contacts the impeller the impeller rotates. Rotation of the impeller causes the gear coupled to the impeller to rotate, which, in turn, causes the weight coupled to the impeller rotate as well. As the gears rotate, a radial force is produced. In embodiments, where the oscillation device is positioned in the head of the massage device, the radial force developed by the oscillation device causes the head to pivot about the handle of the massage device. The rotational movement of the head may be limited by one or more springs. Thus, the head is able to rotate a limited distance before a spring returns the head to the head's resting position. The head may then be rotated in an opposite direction a limited amount. The speed and massaging action produced by the massage device may be controlled with controllers positioned in the handle.

These and other embodiments may be described in more detail below.

### BRIEF DESCRIPTION OF THE DRAWINGS

The following figures depict these and other features of the invention in which:

FIG. 1 is a perspective view of a massage device according to one or more aspects of this invention;

FIG. 2 is an exploded view of the massage device of FIG. 1;

FIG. 3 is a perspective view of a weight included in the device shown in FIG. 2;

FIG. 4 shows the weight of FIG. 3 coupled to a gear and positioned in multiple positions relative to the gear;

FIG. 5 depicts an oscillation device which is depicted as an element in FIG. 1;

FIG. 6 depicts the oscillation device shown in FIG. 5 in a different rotational position when the gears are rotated in an opposite direction than the direction depicted in FIG. 5 and the center of mass of the weights are at different positions relative to rotational axes of the gears;

FIG. 7 is a perspective view of the oscillation device shown in FIG. 5;

FIG. 8 is a perspective view of an alternative embodiment of the oscillation device;

FIG. 9 is a perspective view of an alternative embodiment of the oscillation device of FIG. 8;

FIG. 10 is a perspective view of the oscillation device shown in FIG. 8 rotating in a first direction;

FIG. 11 is a perspective view of the oscillation device shown in FIG. 8 rotating in a second direction, which is opposite to the first direction;

FIG. 12 is a perspective view of an alternative embodiment of the oscillation device;

FIG. 13 is an exploded perspective view of the oscillation device shown in FIG. 12;

FIG. 14 is a perspective view of an alternative embodiment of the oscillation device;

FIG. 15 is a perspective view of another alternative embodiment of the oscillation device rotating in a first direction;

FIG. 16 is a perspective view of the alternative embodiment of the oscillation device shown in FIG. 15 rotating in a second direction, which is opposite to the first direction;

FIG. 17 is a top view of an alternative embodiment of a weight pivotably coupled to a gear rotating in a first direction;

FIG. 18 is a top view of the alternative embodiment of a weight pivotably coupled to the gear shown in FIG. 17 rotating in a second direction, which is opposite to the first direction;

FIG. 19 is a top view of an alternative embodiment of a weight pivotably coupled to a gear rotating in a first direction;

FIG. 20 is a top view of the alternative embodiment of a weight pivotably coupled to the gear shown in FIG. 18 rotating in a second direction, which is opposite to the first direction;

FIG. 21 is top view of the cam shown in FIGS. 15 and 16 when rotated in a first direction;

FIG. 22 is a top view of the cam shown in FIGS. 15 and 16 when rotated in a second direction;

FIG. 23 is an exploded perspective view of an alternative embodiment of an impeller;

FIG. 24 is a top view of an alternative embodiment of an impeller having a weight pivotably coupled to the impeller;

FIG. 25 is a partial side view of the massage device of this invention with an additive emitting chamber;

FIG. 26 is a partial side view of the massage device of this invention shown with an alternative additive emitting chamber;

FIG. 27 is a partial side view of the massage device of this invention shown with another alternative additive emitting chamber;

FIG. 28 is a side view of this invention depicting a massage device coupled to a fluid supply system having a showerhead;

FIG. 29 is a side view of this invention depicting an alternative massage device coupled to a fluid supply system having a showerhead;

FIG. 30 is a side view of an alternative system for controlling fluid flow to a massage device of this invention;

FIG. 31 is a side view of the massage device of this invention shown in use;

FIG. 32 is a side view of the massage device of this invention shown in use with an alternative oscillation device and a flexible handle portion;

FIG. 33 is a side view of the massage device of this invention shown in use with one of the oscillation devices shown in FIGS. 14-16;

FIG. 34 is a side view of the massage device of this invention shown in use with one of the oscillation devices shown in FIGS. 8-11, 12 or 13;

FIG. 35 is a top view of a cam in a first position usable the oscillation device shown in FIG. 15; and

FIG. 36 is a top view of the cam shown in FIG. 35 is a second position shown in FIG. 16.

### DETAILED DESCRIPTION OF THE INVENTION

This invention is directed to a massage device 10 capable of generating a massaging action. The massage device 10 may be a handheld device that can be positioned in a variety of places to impart a massaging action on a human or an animal, which may provide comfort or relieve stress, or both. In at least one embodiment, the massage device 10 may be driven by a fluid jet, which may produce percussive or other forces that can be delivered to tissue or muscle when the device is positioned proximate to a skin surface of a human or animal, which collectively may be referred to hereinafter as a user. In other embodiments of this invention, the massage device 10 may be powered by electrical energy or other power sources. The fluid jet may be, but is not limited to, water.

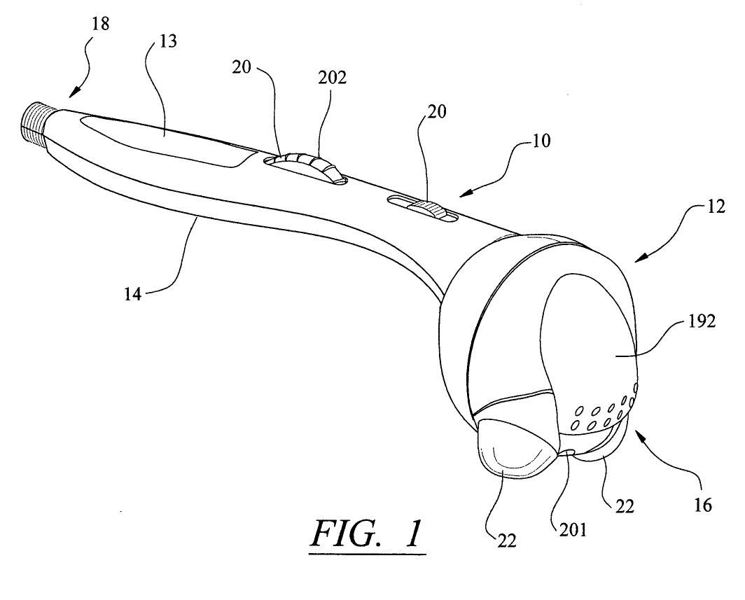

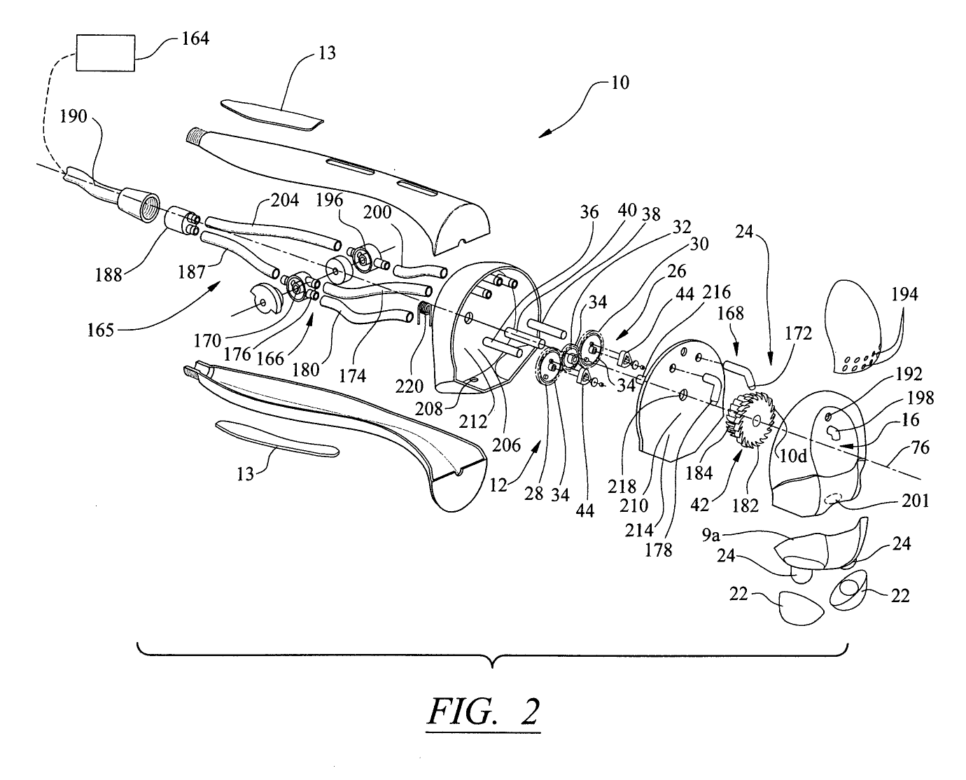

The massage device 10, as shown in FIG. 1, may include a body formed from a head 12 coupled to a handle 14. In at least one embodiment, the head 12 may be pivotably coupled to the handle 14 and may form a distal end 16 of the massage device 10 while the handle 14 may form a proximal end 18. The handle 14 may be formed into a variety of shapes for assisting a user to massage various parts of the user's body or the body of another person or an animal. For instance, the handle 14 may be parallel to a longitudinal axis of the massage device 10, generally orthogonal to the longitudinal axis, or in other positions. The handle 14 may also have different lengths. The massage device 10 may be formed from a rigid material, such as, but not limited to, plastic, such as polyvinyl chloride (PVC), and other appropriate materials. In at least one embodiment, the handle 14 may be ergonomically configured to fit into the palm of a user's hand. In at least one embodiment, the handle 14 may be formed from two or more pieces, as shown in FIG. 2. The handle may also include a pad 13 for providing a stable gripping surface. In at least one embodiment, the head 12 may be pivotably coupled to the handle 14 such that the head 12 may rotate relative to the handle 14 to produce a massaging action. The handle 14 may also include controls 20 for controlling the massage device 10.

The massage device 10, as shown in FIG. 2, may include a plurality of massage heads 22 attached to the head 12. The massage heads 22 may be configured so that during operation of the massage device 10, the massage heads 22 may impart a force generated by the massage device 10 to a user. The massage heads 22 may be fixedly attached to protrusions 24 extending from the head 12. In another embodiment, the massage heads 22 may be releasably attached to the head 12. The massage heads 22 may be formed from a deformable material capable of absorbing and delivering forces.

The head 12 and correspondingly, the massage heads 22, may be rotated by an oscillation device 26. The oscillation device 26 may be any device capable of oscillating the head 12 back and forth about the handle 14. In at least one embodiment, the oscillation device 26 may pivot from a starting position, to a first position that is between about 5 degrees and about 20 degrees from the starting position, and back through the starting position to a second position that is between about 5 degrees and about 20 degrees from the starting position in a direction opposite to the first position. The pivoting of the head may be limited by a rotation limiting device, described in detail below. With such oscillation, the massage heads may be placed in motion for massaging a user when in contact with the user. The oscillating device 26 is able to generate the massaging action produced by the massage device 10.

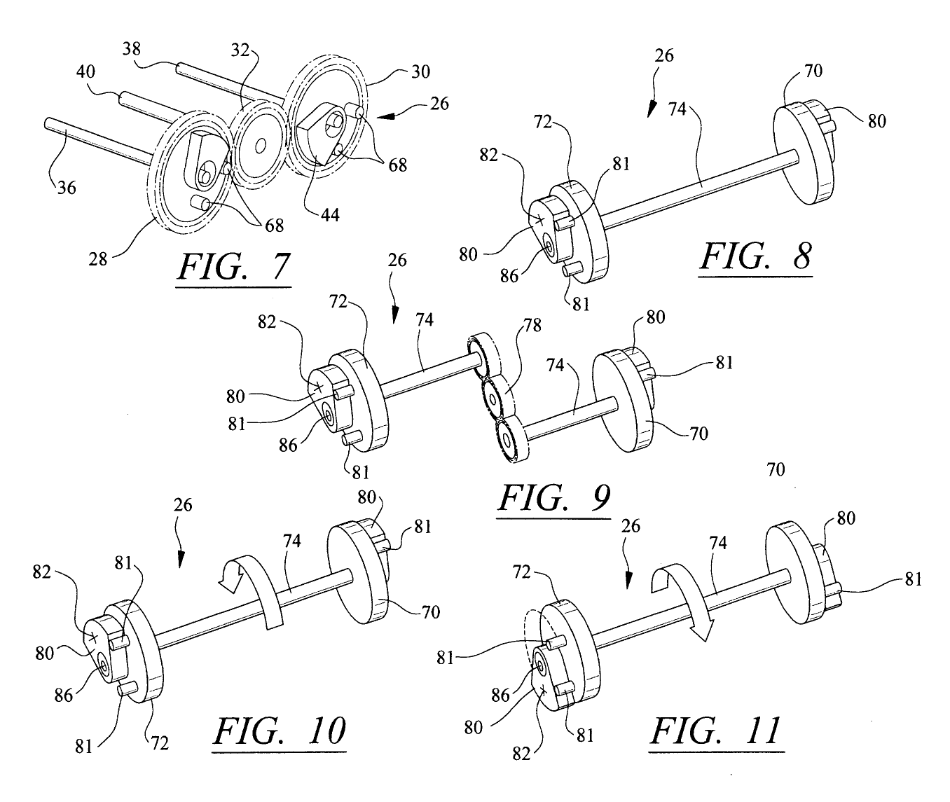

In at least one embodiment, as shown in FIG. 2, the oscillation device 26 may include a first drive gear 28, a second drive gear 30, and a center drive gear 32. Each of the drive gears 28, 30, and 32 may have a plurality of teeth 34 configured to mesh together. The drive gears 28, 30, and 32, may be supported in the massage device with shafts 36, 38, 40, respectively. In at least one embodiment, as shown in FIG. 7, the center drive gear 32 may be coupled to an impeller 42 for driving the oscillation device 26. In other embodiments, the impeller 42 may be coupled to the first drive gear 28 or the second drive gear 30.

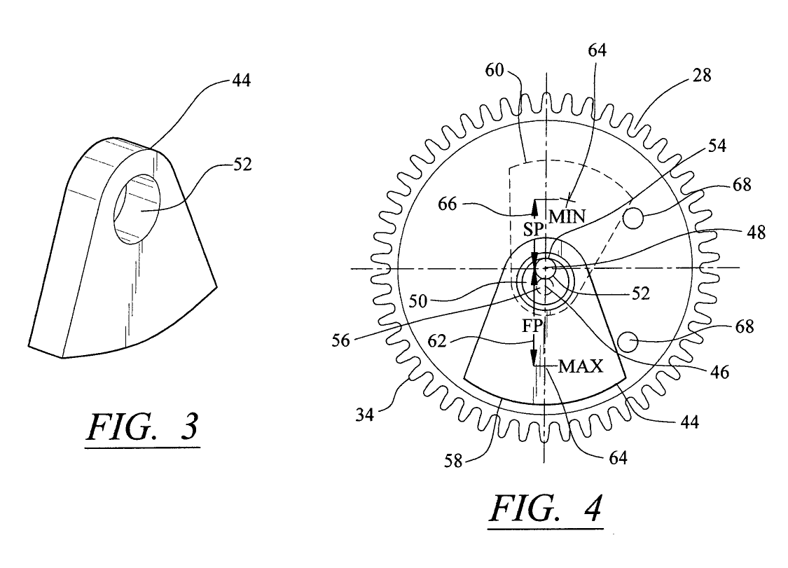

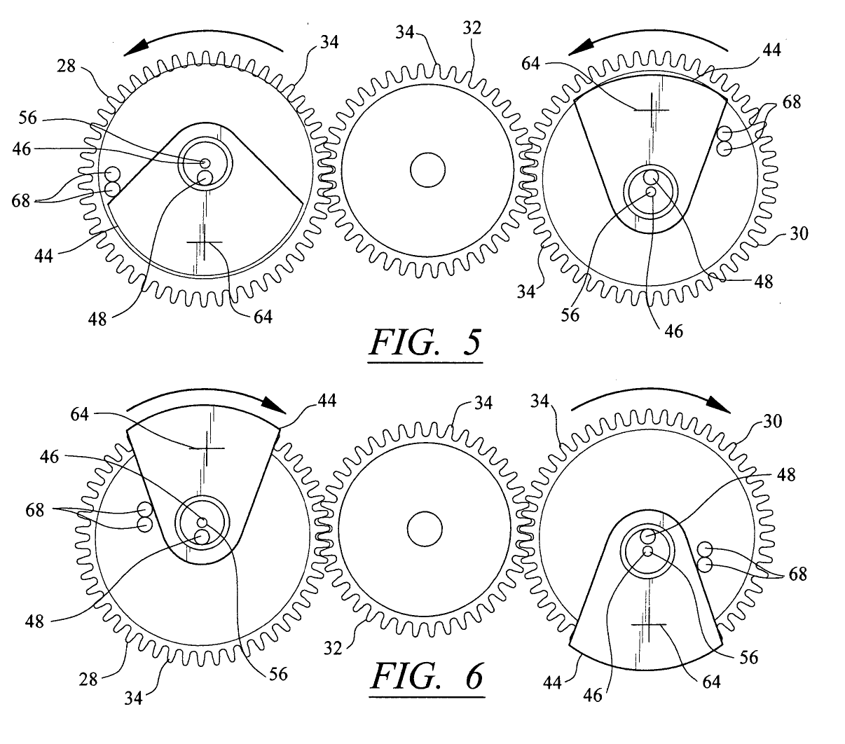

As shown in FIGS. 3 and 4, the first drive gear 28 may include one or more weights 44. The weight 44 may be fixedly or releasably attached to the first drive gear 28. In at least one embodiment, both the first drive gear 28 and the second drive gear 30, as shown in FIGS. 5 and 6, may include one or more weights 44. The center of mass 64 of the weights 44 may be offset from the rotational axis 48 of the first and second drive gears 28 and 30. By offsetting the location of the center of mass 64 of the weights relative to the rotational axis 48 of the first and second drive gears 28 and 30, a radial force may be generated by the drive gears 28 and 30 when the drive gears 28 and 30 are rotated. As the distance between the center of mass of a drive gear 28 or 30 and the rotational axis 48 is increased, or the weight of the weight 44 is increased, the radial forces generated by the rotating drive gear 28 or 30 increase, which provides different massaging actions to a user.

In at least one embodiment, as shown in FIG. 4, the weight 44 may be pivotably coupled to the first drive gear 28. The weight 44 may be coupled to rotate about an axis 46 that is offset from the rotational axis 48 of the first drive gear 28. In at least one embodiment, an insert 50 may be pivotably coupled to the weight 44. As shown in FIG. 3, the insert 50 may include an orifice 52 capable of being aligned with an orifice 54 in the first drive gear 28 for receiving the shaft 36. As shown in FIG. 4, the insert 50 may be attached to the first drive gear 28 with a connection device 56. The connection device 56 may be, but is not limited to, a screw, bolt, or other connection device. The connection device 56 may form axis 46 about which the weight 44 rotates. The weight 44 attached to the second drive gear 30 may have an identical configuration.

The weight 44 may rotate from a first position 58, as shown in FIG. 4, to a second position 60, as shown in phantom lines in FIG. 4. The distance FP 62 between the rotational axis 48 and a center of mass 64 is not equal to the distance SP 66 between the rotational axis 48 and the center of mass 64. In at least one embodiment, the first position 58 of the weight 44 is rotated about 180 degrees from the second position 60 of the weight 44. In other embodiments, the second position 60 of the weight 44 may be rotated about 185 degrees to about 200 degrees from the first position 58 of the weight 44. By rotating the weight 44 to between about 185 degrees and about 195 degrees from the first position, the weight 44 is prevented from inadvertently moving to the first position while the oscillating device 26 is being rotated in a direction such that the weight 44 should be in a second position. The weight 44 may be restrained from traveling greater amounts than these ranges with one or more stops 68. The size, shape, and number of the stops 68 needed to limit the rotation of the weight 44 within this range of motion is dictated, in at least one embodiment, by the size and shape of the weight 44. Thus, in embodiments where the weight 44 covers a relatively large portion of the gear, a single stop 68 may be sufficient. In other embodiments, two or more stops 68 may be needed.

FIGS. 5 and 6 show weights 44 rotatably attached to first and second drive gears 28 and 30. As shown in FIG. 5, the weights 44 may be positioned in a first position on the first and second drive gears 28 and 30 so that the center of mass 64 of the weights are closer to the rotational axis 48 of the drive gears 28 and 30 than the center of mass 64 is relative to the rotational axis 48 in a second position, as shown in FIG. 6. Positioning the weights 44 in the second position shown in FIG. 6 allows a greater radial force to be developed when rotating the first and second drive gears 28 and 30 than when the gears 28 and 30 are rotated with the weights 44 in first position. The weights 44 may be positioned in the first position by rotating the first and second drive gears 28 and 30 in, for instance, a counterclockwise direction, as shown in FIG. 5. The weights 44 may be moved into the second position by rotating the first and second drive gears 28 and 30 in an opposite direction, which may be a clockwise rotation, as shown in FIG. 6. Operating the massage device 10 with weights positioned in the first position, as shown in FIG. 5, produces a fast repetitive action with a small distance of travel of the massage heads 22. On the other hand, operating the massage device with weights positioned in the second position, as shown in FIG. 6, produces a slower repetitive action with a larger distance of travel of the massage heads 22 than the massage heads 22 in the first position shown in FIG. 5.

FIGS. 5-7 depict the weight 44 on the first drive gear 28 as being 180 degrees out-of-phase with the weight 44 on the second drive gear 30. Positioning the first and second drive gears 28 and 30 in this manner can produce a oscillating massaging action in massage heads 22. However, operation of the massage device 10, and more specifically, the configuration of the oscillation device 26 is not limited to this relationship. Instead, the weights 44 on the first and second drive gears 28 and 30 may be positioned relative to each other so that the weights 44 are in-phase with each other. Operating the massage device 10 while the weights 44 are in-phase with each other produces a massage action having the same pace as operating the device 10 with out of phase weights; however, a greater amount of force is imparted by the massage heads 22 when the weights 44 are rotated in-phase with each other.

FIGS. 8-11 depict an alternative embodiment of the oscillation device 26. The oscillation device 26 may be formed from a first drive gear 70, a second drive gear 72, and one or more shafts 74 coupling the first and second drive gears 70 and 72 together. At least one of the first and second drive gears 70 and 72 may be positioned generally orthogonal to the shaft 74 about which the gears 70 and 72 may rotate. When placed in a massage device 10, such as in a handle 14, the first and second drive gears 70 and 72 may be positioned so that the gears 70 and 72 rotate generally parallel to a longitudinal axis 76 of the massage device 10. In addition, the first and second drive gears 70 and 72 may be positioned generally parallel to a longitudinal axis 76 of the massage device 10.

As shown in FIG. 9, the shaft 74 may be composed of two shafts, which may be coupled together with a center drive gear 78. Weights 80 may be coupled to the first and second drive gears 70 and 72. The weights 80 may be rotatable relative to the gears 70 and 72. Stops 81 may be used to position the weights 80 in either a first position, as shown in FIG. 10, when the shaft 74 is rotated in a first direction, or in a second position, as shown in FIG. 11, when the shaft is rotated in a second direction, which is opposite to the first direction. The center of mass 82 of the weights 80 may be at different distances from the rotational axis 86 about which the first and second drive gears 70 and 72 rotate. This may be accomplished by making the axis 88 about which the weight 80 rotates offset from the rotational axis 86 about which the first and second drive gears 70 and 72 rotate.

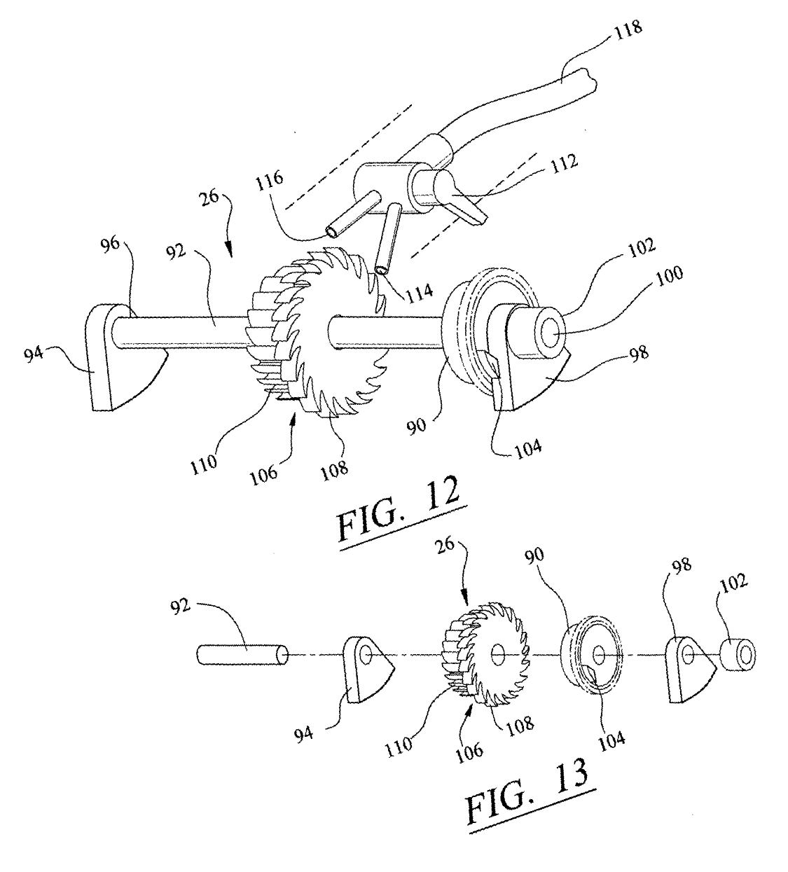

Another alternative embodiment of the oscillation device 26 is shown in FIGS. 12 and 13. The oscillation device 26 may be formed from a drive gear 90 coupled to a shaft 92. A first weight 94 may be fixedly attached to the shaft 92 at a first end 96, and a second weight 98 may be rotatably attached to a second end 100, which is generally opposite to the first end. The second weight 98 may be held in place with a collar 102. As shown in FIG. 12, the second weight 98 may be in-phase with the first weight 94. The shaft 92 may also be rotated so that the second weight 98 is about 180 degrees out-of-phase from the first weight 94. The second weight 98 may be held in this position by stop 104. The shaft 92 may be driven by an impeller 106. The impeller 106 may include a first section 108 having teeth facing a first direction for receiving a fluid jet and rotating the shaft 92. The impeller 106 may also include a second section 110 having teeth facing a second direction that is generally opposite to the teeth in the first section 108 for receiving a fluid jet and rotating the shaft 92 in an opposite direction.

A fluid jet may be used to drive the impeller 106. The fluid jet may be controlled by a valve 112. The valve 112 may be capable of directing the fluid jet towards the first section 108 or the second section 110. In at least one embodiment, the valve 112 may include a first nozzle 114 directed toward the first section 108 and a second nozzle 116 directed toward the second section 110. A conduit 118 may be connected to the valve 112.

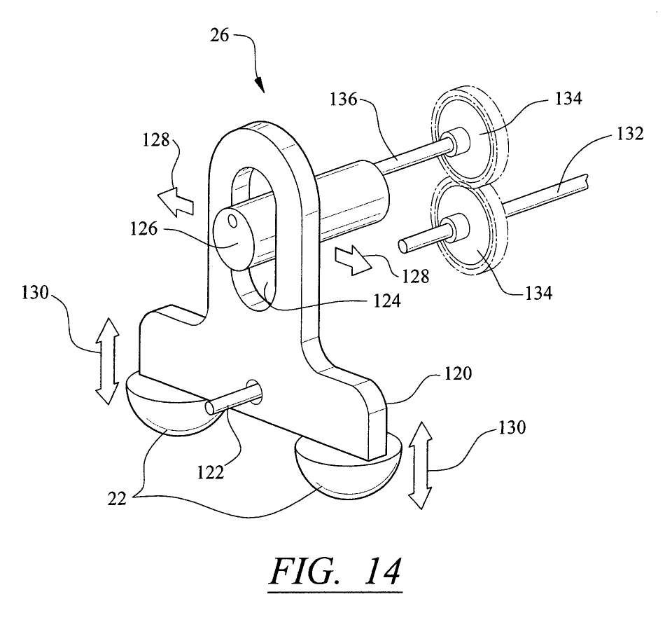

Another alternative embodiment of the oscillation device 26 is shown in FIGS. 14-16. The oscillation device 26 shown in FIGS. 14-16 may be formed from a body 120.

Body 120 may rotate about a shaft 122. The body 120 may also include a slot 124 for receiving a cam 126. The cam 126 may be driven by a water driven impeller, such as the impeller 106 shown in FIGS. 12 and 13. As the cam 126 is rotated, the body 120 oscillates about the shaft 122, as indicated by arrows 128, which, in turn, moves massage heads 22 as shown by arrows 130. Rotational motion may be transferred from the water driven impeller (not shown) to the cam 126 through a shaft 132, a plurality of gears 134, and a shaft 136.

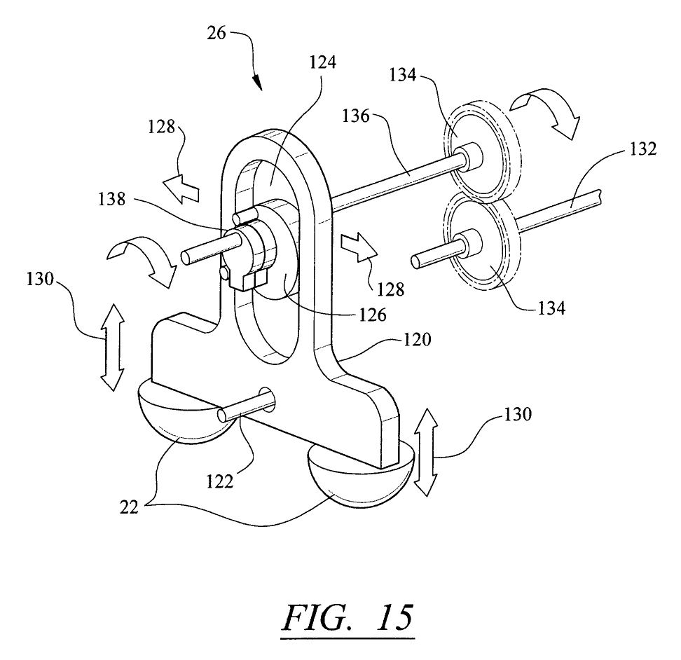

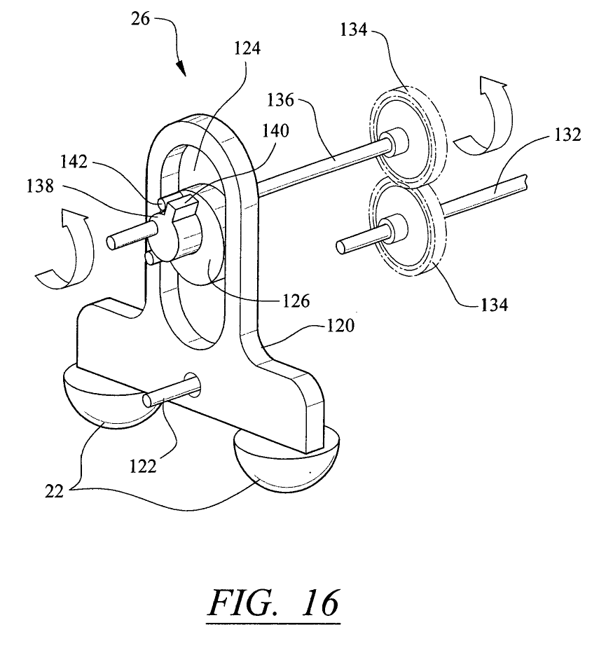

As shown in FIG. 15, oscillation device 26 may include a second cam 138. The second cam 138 may cooperate with the cam 126 to produce a first action when the shaft 136 rotates in a first direction, which may be clockwise, as shown in FIGS. 15 and 35. If the shaft 136 rotates in a second direction, which may be counterclockwise, as shown in FIGS. 16 and 36, the second cam 138 may rotate until protrusion 140 strikes stop 142 and produce a second action that may be different from the first action. The distance between the shaft 136 in the second position, as shown in FIG. 16, and a center of the cam 126 is greater than the distance between the shaft 136 in the first position, as shown in FIG. 15, and the center of the cam 126. Thus, the action produced by the massage heads 22 when the shaft 136 is rotated in a first direction, as shown in FIG. 15, is different than the action produced by the massages heads 22 when the shaft 136 is rotated in a second direction, as shown in FIG. 16. In at least one embodiment, moving the second cam 138 in the first direction may produce small oscillations, and moving the second cam 138 in a second direction may produce large oscillations. The second cam 138 is shown in detail in FIGS. 35 and 36. The second cam 138 may include a slot 160 for receiving a shaft 162 coupled to the cam 126. FIGS. 15 and 35 depict the second cam 138 in the first position, and FIGS. 16 and 36 depict the second cam 138 in the second position, as depicted in FIG. 16.

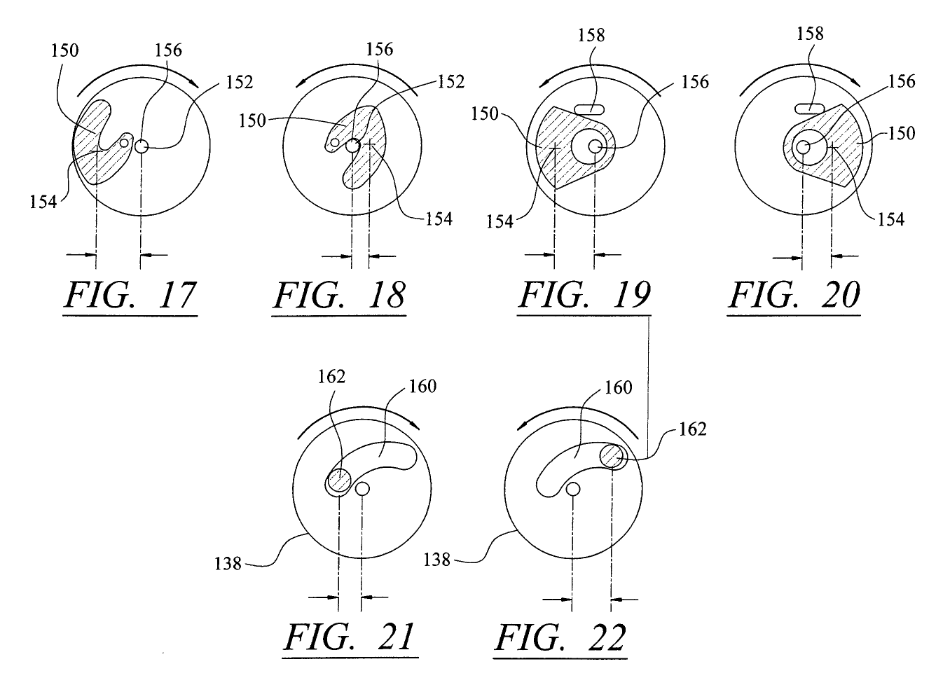

The oscillation device 26 may include one or more weights, as previously described. The weights may have various configurations, as shown in FIGS. 17-20. The weight 150 may be shaped as a boomerang, as shown in FIGS. 17 and 18, as a pie shape, as shown in FIGS. 19 and 20, or as any other appropriate shape. A shaft 152 may be located at the center of rotation of the gear 154 and may be used to control the position of the boomerang shaped weight 150. The weight 150 may move from a first position, as shown in FIG. 17, to a second position, as shown in FIG. 18. The distance between the center of mass 154 of the weight 150 and the center of rotation 156 of the gear is decreased between the first position and the second position. The forces generated by the weight 150 in the second position, as shown in FIGS. 18 and 20, are generally less than the forces generated by the weight 150 in the first position, as shown in FIGS. 17 and 19. The weight 150 shown in FIGS. 18 and 20 may be controlled using stop 158 attached to the gear 154.

The oscillation device 26 may be driven by mechanical motion, electrical energy or other forms of power. In at least one embodiment, the oscillation device 26 may be driven with one or more fluid jets. As shown in FIG. 2, the massage device 10 may include a fluid jet supply system 165. The fluid jet supply system 165 may include one or more valves 166 for controlling the supply of water to the impeller 42. In one embodiment, the valve 166 may be capable being moved between an open state and a closed state and may have a single outflow. In yet another embodiment, as shown in FIG. 2, the valve 166 may be capable of directing a fluid to one of two or more outlets 168 and may be placed in a closed state, thereby preventing fluids from flowing out of any of the outlets 168. The valve 166 may operate along a continuum such that the amount of flow out of each outlet 168 may be anywhere between zero flow and full flow. A first outlet 170 of the valve 166 may be coupled to a first nozzle 172 using conduit 174. A second outlet 176 of the valve 166 may be coupled to a second nozzle 178 using conduit 180. The first nozzle 172 may be positioned so that the fluid jet emitted from the first nozzle 172 is directed toward a first section 182 of the impeller 42 to rotate the impeller 42 in a first direction. The second nozzle 178 may be positioned so that the fluid jet emitted from the second nozzle 178 is directed toward a second section 184 of the impeller 42 to rotate the impeller 42 in a second direction that is generally opposite to the first direction.

The first section 182 of the impeller 42 may be larger or smaller than the second section 184. Each section 182 and 184 may include a plurality of teeth 186 configured to catch the fluid jet and transfer forces from the fluid jet to a shaft to which the impeller 42 is attached. In embodiments where the first and second sections 182 and 184 are different sizes, the impeller 42 will rotate at different speeds depending on whether a fluid is emitted from the first nozzle 172 or from the second nozzle 178. In other embodiments, the first and second sections 182 and 184 of the impeller 42 may be the same size and thus, may rotate at the same sped regardless of which section of the impeller 42 contacts the fluid jet, assuming a constant velocity of the fluid jet striking the impeller 42.

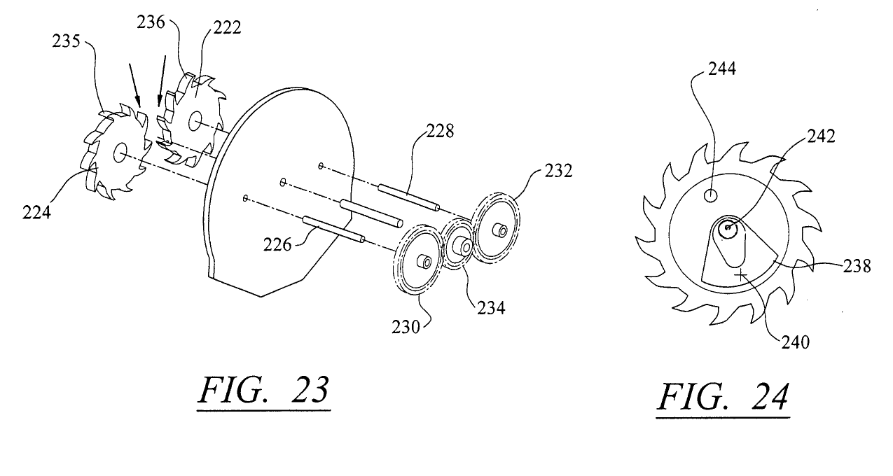

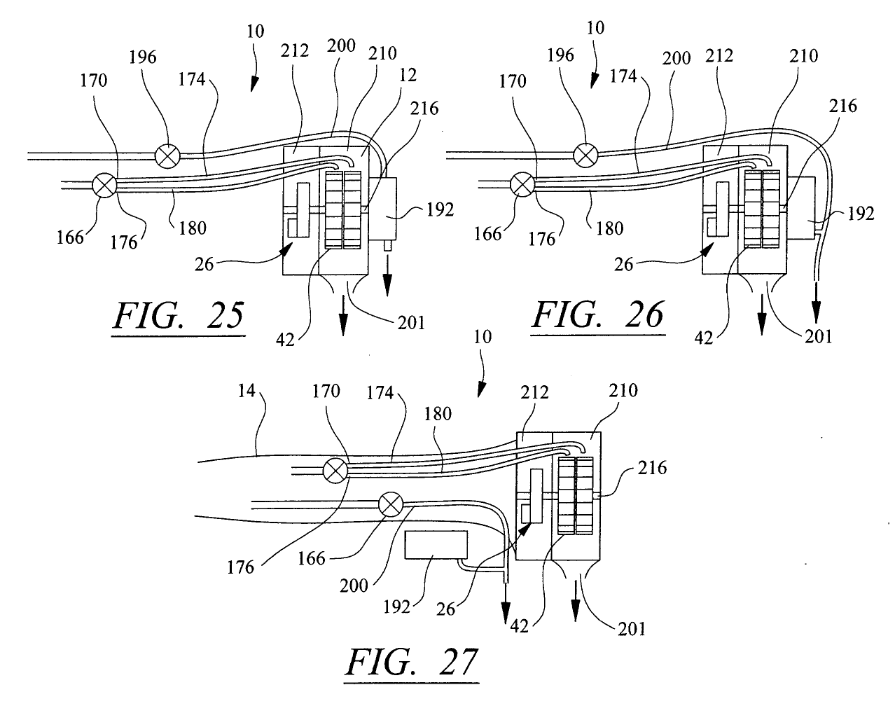

The oscillation device 26 may be driven using one or more impellers 42, as shown in FIGS. 2, 12 and 13, as previously described. Rather than using only a single impeller 42 coupled to a center drive gear 32, as shown in FIG. 2, an alternative configuration shown in FIGS. 23 and 24 may be composed of two or more impellers 222 and 224. Each impeller 222 and 224 may be fixedly attached to a shaft 226 and 228, respectively, that may in turn be attached to drive gears 230 and 232. A center drive gear 234 may be positioned between the drive gears 230 and 232 so that the drive gears 230 and 232 may rotate in the same direction. In an alternative embodiment, the drive gears 230 and 232 may contact each other directly so that each gear 230 and 232 rotates in an opposite direction relative to each other. The impellers 222 and 224 each have teeth 235 and 236, respectively, for catching a fluid jet. The teeth 234 on the impeller 222 may be positioned oppositely to the teeth 236 on the impeller 224 to rotate the impeller 222 in a direction opposite to the direction of rotation of the impeller 224.

As shown in FIG. 24, either impeller 222 or 224, or both, may have a weight 238 attached to the impeller. The weight 238 may be rotatably attached and capable of moving between at least first and second positions where a distance between a center of mass 240 of the weight 238 and an axis of rotation 242, thereby producing different amounts of force for transmission to a user's skin surface via the massage heads 22 depending on the position of the weight 238. A stop 244 may be used to position the weight 238 in the first or second position.

As shown in FIG. 2, the valve 166 may be coupled to a conduit 187 for receiving a fluid from a fluid supply source 164. The fluid supply source 164 may be a public utility system, a well, a gravity feed system or other device. In at least one embodiment, the conduit 187 may be coupled to a fitting 188 for splitting the flow of water. The fitting 188 may also be configured to be coupled to a flexible hose 190, which may in turn be coupled to a standard shower fitting or other device.

In at least one embodiment, the massage device 10 may also include an additive emitting chamber 192 for emitting additives, such as, but not limited to, lotions, soaps, fragrances, and other materials during use of the massage device 10. The additive emitting chamber 192 may be positioned on the distal end 16 of the head 12, as shown in FIGS. 2, 23, and 24. In other embodiments, as shown in FIG. 27, the additive admitting chamber 192 may be positioned proximate the head 12 or handle 14 of the massage device 10. As shown in FIG. 2, the additive emitting chamber 192 may include one or more holes 194 for emitting an additive from the massage device 10. An additive may be emitted by sending a fluid jet into the additive emitting chamber 192. The fluid jet released into the additive emitting chamber 192 may be controlled using a valve 196. The valve 196 may be coupled to a nozzle 198 positioned to emit a fluid into the additive emitting chamber 192. A conduit 200 may connect the nozzle 198 to the valve 196. Additives may be added to the additive emitting chamber 192 whenever necessary.

Emitting additives together with a fluid flowing through the massage device 10 may add to the massage effect delivered by the massage device 10 by adding heat, scent, texture, and other items. For instance, the temperature of the fluid sent through the massage device 10 may be warm so as to provide heat to the massaged area of a user to supplement the massaging effect of the fluid. While additives may be emitted from the additive emitting chamber 192, fluids used to drive the impeller 42, 106, 222, and 224 may be emitted through one or more orifices 201 in the head 12 as well and may enhance the massaging action. In particular, the fluids emitted through the orifice 201 may provide additional massaging action. The orifice 201 may be referred to as a drip hole in some embodiments. The fluids may provide heat in some embodiments. In at least some embodiments where an additive emitting chamber 192 is not included in the massage device 10, fluids may be emitted through the orifices 201 to enhance the effects of the massage action created by the massage device. The orifices 201 may be positioned in the head 12 proximate to the massage heads 22.

The valve 196 may be placed in an open state, a closed state, or anywhere along a continuum between the open state and the closed state. The valve 196 may be adjusted by rotating a dial 202 that is exposed in the handle 14. The dial 202 may have visual indications of the state of the valve 196. A conduit 204 may be coupled to the valve 196 to connect the valve 196 to the fitting 188.

In at least one embodiment, the head 12 of the massage device 10 may be formed from at least one chamber 206 for containing the oscillation device 26. In embodiments where the oscillation device 26 is driven by a fluid, the chamber 206 may include a drain 208 for draining the fluid from the chamber 206. In at least one embodiment, as shown in FIG. 2, the chamber 206 may include a plate 214 forming an upper chamber 210 and a lower chamber 212. The upper chamber 210 may be sized and configured to contain the impeller 42, and the lower chamber 212 may be sized to contain at least a portion of the oscillation device 26. The upper chamber 210 contains substantially all of the water emitted from the first or second nozzles 172 or 178 while the plate 214 can prevent substantially all of the water from entering the lower chamber 212. The plate 214 may be positioned in the head 12 to form a side of the upper chamber 210 and prevent fluids from entering the lower chamber 212 from the upper chamber 210. The plate 214 shields the oscillation device 26 from contact fluid contained in the upper chamber 210. In this embodiment, a drive shaft 216 may be coupled to the impeller 42 and pass through an orifice 218 in the plate 214. The drive shaft 216 may be positioned in various manners to provide rotational motion to the oscillation device 26.

The head 12 may be pivotably coupled to the handle 14. In at least one embodiment, the range of motion of the head 12 relative to the handle 14 may be limited. For instance, the head 12 may only be able to pivot clockwise or counter clockwise from a resting position about 5 to about 20 degrees. In other embodiments, the head 12 may be restricted to a more narrow range or expanded to a broader range. In the embodiment shown in FIG. 2, movement of the head 12 may be limited with one or more rotation limiting devices, which may be, but is not limited to, a spring 220. The spring 220 may have two arms for contacting ribs (not shown) in the head 12 limiting rotation of the head 12 relative to the handle 14. During use the spring 220 may load when the head 12 is rotated near the limit and may release a force to return the head 12 to a resting position.

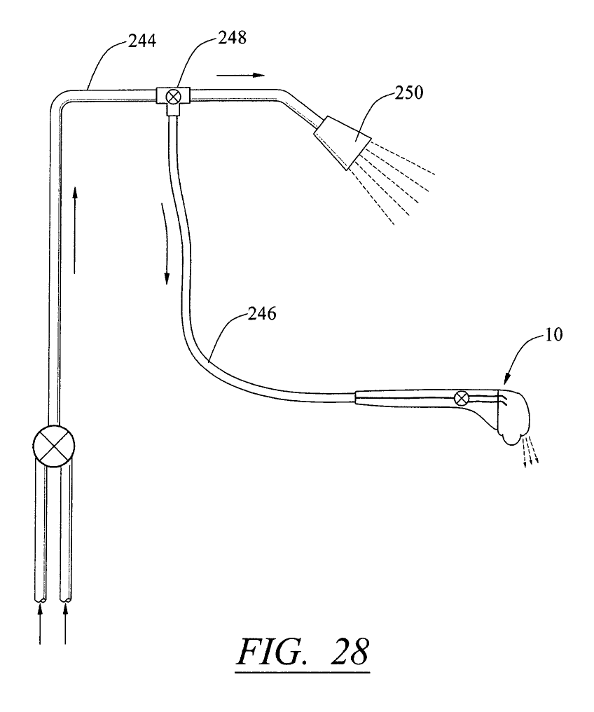

During operation, the massage device 10 may be used to apply repetitive forces to a surface of a human, animal, or other object. The massage device 10 may be coupled to a fluid supply line 244, as shown in FIG. 28. The massage device 10 may be coupled to the fluid supply line 244 using a conduit 246. In at least one embodiment, the conduit 246 may be a flexible hose that may have a length between about three feet and about ten feet. The conduit may be connected to the fluid supply line 244 using a fitting 248. The fitting 248 may be a conventional “T” fitting or may be another type fitting. In at least one embodiment, the fitting 248 may include a valve for controlling the flow of a fluid to the massage device 10 and to a showerhead 250.

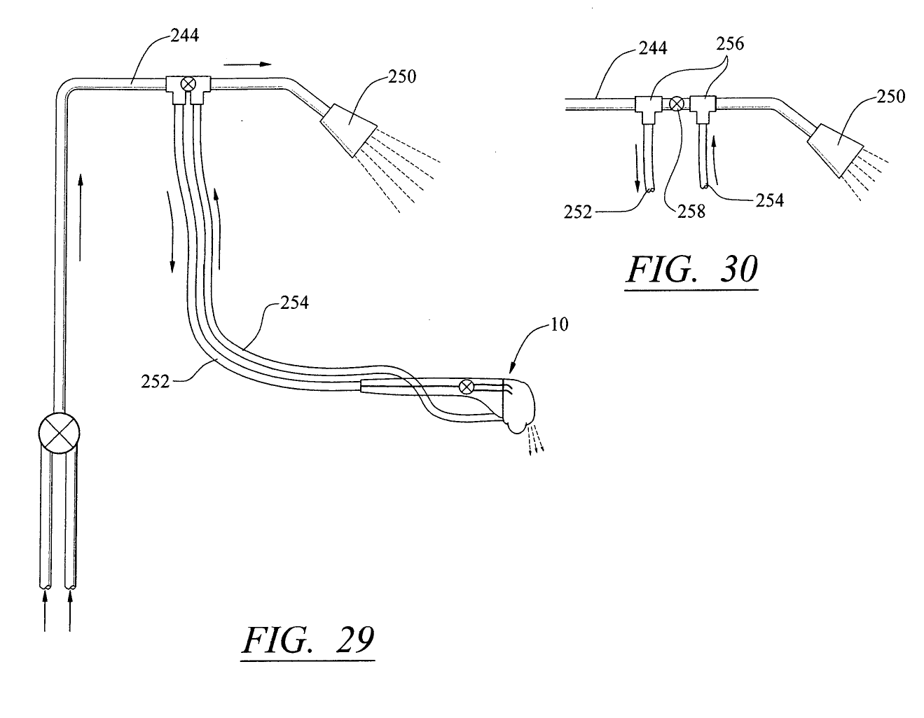

As shown in FIG. 29, the massage device 10 may be configured so that at least a portion of the fluid received from the fluid supply line 244 may be returned to the fluid supply line 244. A fluid may travel from the fluid supply line 244 through a conduit 252 to the massage device 10. A portion of the fluid may or may not be emitted from the massage device 10. At least a portion of the fluid may be returned to the fluid supply line 244 through a conduit 254. The conduits 252 and 254 may be coupled to the fluid supply line 244 through one or more fittings 256. A valve 258 may be incorporated in the fluid supply line 244 or may be positioned between two fittings 256, as shown in FIG. 30. If the valve 258 is open, a fluid may flow through the fluid supply line 244 and be emitted out of the showerhead 250 and a portion of the fluid may or may not flow to the massage device 10. If the valve 258 is closed, the fluid will flow through conduit 252 to the massage device 10. The fluid 258 will then be returned from the massage device 10 through the conduit 254 and emitted from the showerhead 250.

The massage device 10 may operate in various modes. In some modes, the massage device produces a fast repetitive action whereby the head 12 oscillates back and forth about the handle 14 and there is relatively little displacement of the massage heads 22. In this embodiment, each massage head 22 may strike a surface of a user while the other massage head 22 is being withdrawn from the surface. Thus, the massage heads 22 alternate striking a surface. The massage device 10 may be operated in a first mode in a relatively fast repetitive action or may be operated in a second mode that is slower than the first mode, but may deliver more force through the massage heads 22 to a user, thereby producing a stronger massaging effect because the massage heads 22 undergo a larger displacement than the displacement of the massage heads 22 while the massage heads 22 are operating at a faster pace.

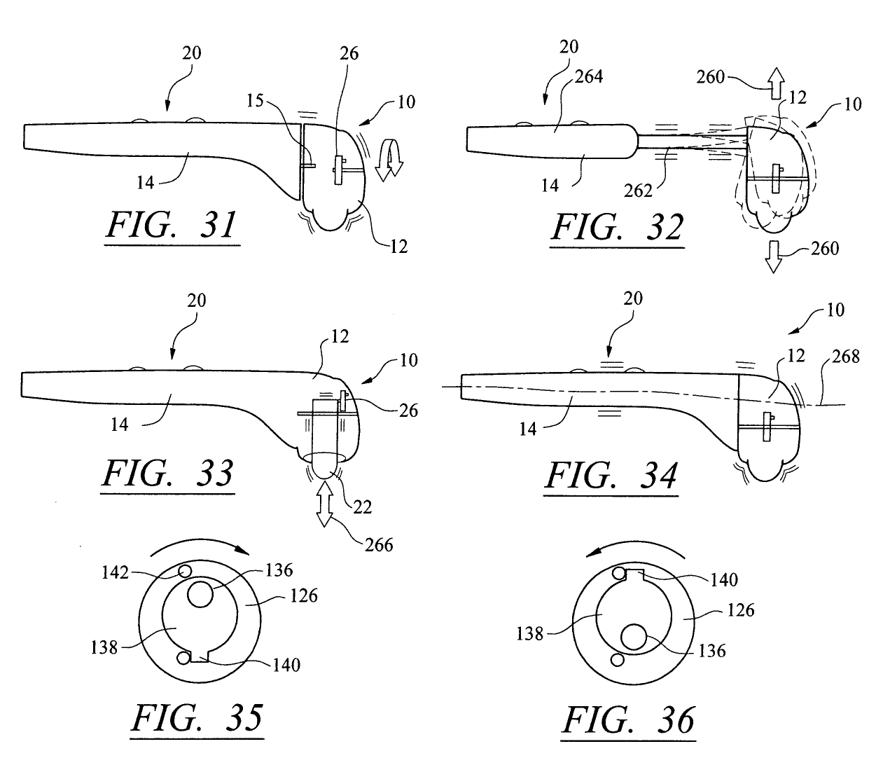

As a fluid flows through the massage device 10, the controls 20 shown in FIG. 1, may be used to control the action of the massage device 10. FIGS. 31-34 depict the various actions that may be produced by the massage device, depending on which oscillation device 26 is installed in the massage device 10. FIG. 31 depicts an embodiment in which the head 12 rotates about the handle 14. In this embodiment, the oscillation device 26 may be composed of the elements shown in FIG. 2, 5, 6, or 23. In this embodiment, the massage device 10 may operate in one of two modes. The massage device 10 may operate in a first mode that has a relatively fast repetitive action, such as between about 2,000 and 3,000 pulses per minute, that emanates from the massage heads 22. The massage device 10 may also operate in a second mode that has a slower repetitive action that has less pulses per minute than does the first mode. The slower repetitive action of the massage device 10, the greater the distance of throw of the massage heads 22. In addition, the larger the throw distance, the larger the massage effect felt by a user. Thus, the faster repetitive action mode delivers less massage effect to a user than a slower repetitive action mode. A user may switch between these modes using the controls 20. The time period between each pulse may be identical in some embodiments, or may differ in other embodiments, as dictated by the position of the gears and the weights on those gears relative to each other.

FIG. 32 depicts an embodiment of the massage device 10 having a handle 14 with a flexible portion 262 positioned between a portion 264 held by a user and the head 12. In this embodiment shown in FIG. 32, the head 12 may vibrate, as indicated by arrows 260. The vibration is produced by rotation of the off-center, out of phase weights 44, which causes a shaking of the head 12 coupled to the flexible portion 262. FIG. 33 depicts an embodiment of the massage device 10 including the oscillation device 26 shown in FIGS. 14-16. In this embodiment, the head 12 does not pivot. Rather, the massage heads 22 move up and down, as shown by the arrows 266. FIG. 34 depicts an embodiment of the massage device 10 where the head 12 may rotate relative to the handle 14 and the handle 14 may move generally along the longitudinal axis 268 of the massage device 10. The massage device depicted in FIG. 34 may have the oscillation device 26 shown in FIGS. 8-13 installed therein.

When the massage device 10 is used, the massage device 10 may be connected to a fluid supply line 244, as shown in FIGS. 28-30. The action of the massage device 10 may be controlled using the controls 20, which may be a first dial and a second dial positioned in the handle 14. The first dial may control the action of the massage heads 22, and the second dial 204 may control emission of an additive. Some embodiments of the massage device 10 may not have the additive emitting chamber 192 and therefore, do not include the second dial 204. A user may place the massage heads 22 in contact with a surface of the user's body of a surface of another person or an animal.

The massage device 10 may be positioned the head 12 of the massage device 10 is in contact with a user. The massage device 10 may be actuated so that a flowing fluid rotates the head 12 of the massage device 10 relative to a handle 14 of the massage device 10. At least a portion of the fluid used to drive the massage device 10 is exhausted from the device 10 in a manner so that at least a portion of this fluid contacts the user. The fluid flowing from the massage device 10 may be warm or hot water, such as greater than about 75 degrees Fahrenheit. The massage device 10 may receive the flowing fluid from a shower head fitting in a shower.

The foregoing is provided for purposes of illustrating, explaining, and describing embodiments of this invention. Modifications and adaptations to these embodiments will be apparent to those skilled in the art and may be made without departing from the scope or spirit of this invention or the following claims.

We claim:

1. A massage device, comprising:
a handle;
a head pivotably coupled to the handle, the head having at least one chamber and at least one massage head adapted to contact a skin surface of a user;
at least one impeller positioned in the at least one chamber and capable of rotating relative to the head;
at least one fluid conduit having at least one outlet positioned proximate to the impeller for contacting a fluid with the at least one impeller, wherein the fluid causes the impeller to rotate; and
at least one oscillation device disposed in the head and coupled to the impeller for moving the head in an oscillatory motion relative to the handle, wherein the at least one oscillation device is substantially shielded from contact by the fluid emitted from the at least one fluid conduit.

2. The massage device of claim 1, wherein the at least one oscillation device comprises at least one gear positioned in the at least one chamber.

3. The massage device of claim 2, wherein the at least one gear is positioned in a plane that is generally orthogonal to a longitudinal axis of the massage device.

4. The massage device of claim 2, wherein the at least one gear is positioned in a plane that is generally parallel to a longitudinal axis of the massage device.

5. The massage device of claim 2, wherein the at least one oscillation device comprises at least one weight coupled to the at least one gear, whereby the at least one weight comprises a center of mass that is capable of moving relative to at least one gear.

6. The massage device of claim 5, wherein the at least one weight comprises at least one cavity, the at least one cavity including at least one insert positioned in the cavity, and the insert coupled to the at least one gear at a point offset from an axis of rotation of the at least one gear.

7. The massage device of claim 2, further comprising at least one stop on the at least one gear for limiting the rotation of at least one weight.

8. The massage device of claim 2, wherein the at least one gear comprises a first gear and a second gear in communication with the at least one impeller through at least one center gear positioned between the first and second gears.

9. The massage device of claim 8, wherein the first and second gears each include at least one weight having a center of mass and the center of mass of the first gear is movable relative to the first gear.

10. The massage device of claim 9, further comprising at least one stop element extending from the first gear for limiting movement of the at least one weight.

11. The massage device of claim 8, wherein the center of mass of the at least one weight attached to the first gear is positioned a first distance from an axis of rotation of the first gear in a first position, and the center of mass of the at least one weight attached to the first gear is positioned at a second distance from an axis of rotation of the first gear in a second position, whereby the first and second distances are not equal.

12. The massage device of claim 9, wherein the center of mass of the at least one weight attached to the first gear is positioned between about 185 degrees and about 200 degrees out-of-phase with the at least one weight attached to the second gear.

13. The massage device of claim 9, wherein the center of mass of the at least one weight attached to the first gear is positioned in-phase with the at least one weight attached to the second gear.

14. The massage device of claim 9, wherein the at least one weight of the first gear is attached to the first gear so that the at least one weight moves relative to the first gear while the at least one weight of the second gear remains substantially motionless relative to the second gear.

15. The massage device of claim 1, wherein the at least one oscillation device comprises at least one body rotatably about a shaft, the body including a slot for receiving a first cam and having at least one massage head coupled thereto, and the first cam positioned in the slot and mechanically coupled to the at least one impeller.

16. The massage device of claim 15, further comprising a second cam pivotably coupled to the first cam for changing the action of the body depending on the direction of rotation of the at least one impeller.

17. The massage device of claim 15, wherein the second cam is positioned relative to the first cam to change between a large oscillation pattern and a small oscillation pattern.

18. The massage device of claim 1, wherein the at least one conduit comprises at least one end capable of being releasably attached to a fitting.

19. The massage device of claim 1, further comprising at least one valve coupled to the at least one conduit for controlling fluid flowing through the at least one conduit and striking the at least one impeller.

20. The massage device of claim 19, wherein the at least one valve is adjustable between an off mode, an open mode allowing fluid to flow through a first outlet, and an open mode allowing fluid to flow through a second outlet, and further comprising at least one conduit coupled to the first outlet and having at least one end positioned proximate to the at least one impeller to expel a fluid to rotate the impeller in a first direction and comprising at least one conduit coupled to the second outlet and having at least one end positioned proximate to the at least one impeller to expel a fluid to rotate the impeller in a second direction that is generally opposite to the first direction.

21. The massage device of claim 20, wherein the at least one impeller comprises a first portion having a first diameter and a second portion having a second diameter that is greater than the first diameter, and wherein the at least one end of the at least one conduit coupled to the first outlet is positioned to expel a fluid from the end to rotate the at least one impeller in the first direction, and the at least one end of the at least one conduit coupled to the second outlet is positioned to expel a fluid from the end to rotate the at least one impeller in the second direction.

22. The massage device of claim 1, further comprising at least one rotation limiting device for limiting a range of rotation of the head relative to the handle.

23. The massage device of claim 22, wherein the at least one rotation limiting device comprises at least one spring positioned between the handle and the head.

24. The massage device of claim 1, further comprising at least one additive emitting chamber for mixing a fluid with an additive contained in the at least one additive emitting chamber.

25. The massage device of claim 24, further comprising at least one valve coupled to at least one conduit for directing fluid into the at least one additive emitting chamber; wherein fluid flow through the valve is adjustable along a continuum between a completely open mode and a completely closed mode.

26. The massage device of claim 1, further comprising at least one orifice in the at least one chamber for releasing a fluid from the head to contact a user.

27. The massage device of claim 1, wherein the head comprises at least one first chamber containing the at least one impeller and at least one second chamber containing the at least one oscillation device.

28. The massage device of claim 27, wherein the at least one oscillation device is positioned in the second chamber, and further comprising a fluid barrier isolating the at least one oscillation device from the at least one chamber and wherein the fluid barrier substantially prevents the fluid from contacting the at least one oscillation device.

29. The massage device of claim 27, further comprising at least one drain positioned in the at least one first chamber for draining fluids.

30. The massage device of claim 27, further comprising at least one drain positioned in the at least one second chamber for draining fluids.

31. A massage device, comprising:
a handle;
a head pivotably coupled to the handle, the head having at least one chamber and at least one massage head adapted to contact a skin surface of a user;
at least one water driven drive means for rotating at least one oscillation means; and
the least one oscillation means for moving the head in an oscillatory motion relative to the handle and for imparting an oscillatory force to the at least one massage head for contacting a user, wherein the at least one oscillation means is disposed in the head and is substantially shielded from contact by a fluid emitted to drive the at least one water driven drive means.

32. The massage device of claim 31, wherein the at least one oscillation means comprises at least one gear positioned in the at least one chamber.

33. The massage device of claim 32, wherein the at least one gear is positioned in a plane that is generally orthogonal to a longitudinal axis of the massage device.

34. The massage device of claim 32, wherein the at least one gear is positioned in a plane that is generally parallel to a longitudinal axis of the massage device.

35. The massage device of claim 32, wherein the at least one oscillation means comprises at least one weight coupled to the at least one gear, whereby the at least one weight comprises a center of mass that is capable of moving relative to at least one gear.

36. The massage device of claim 35, wherein the at least one weight comprises at least one cavity, the at least one cavity including at least one insert positioned in the cavity, and the insert coupled to the at least one gear at a point offset from an axis of rotation of the at least one gear.

37. The massage device of claim 32, further comprising at least one stop on the at least one gear for limiting the rotation of the at least one weight.

38. The massage device of claim 32, wherein the at least one gear comprises a first gear and a second gear in communication with the at least one water driven drive means through at least one center gear positioned between the first and second gears.

39. The massage device of claim 38, wherein the first and second gears each include at least one weight having a center of mass and the center of mass of the first gear is movable relative to the first gear.

40. The massage device of claim 39, further comprising at least one stop element extending from the first gear for limiting movement of the at least one weight.

41. The massage device of claim 38, wherein the center of mass of the at least one weight attached to the first gear is positioned a first distance from an axis of rotation of the first gear in a first position, and the center of mass of the at least one weight attached to the first gear is positioned at a second distance from an axis of rotation of the first gear in a second position, whereby the first and second distances are not equal.

42. The massage device of claim 39, wherein the center of mass of the at least one weight attached to the first gear is positioned between about 185 degrees and about 200 degrees out-of-phase with the at least one weight attached to the second gear.

43. The massage device of claim 39, wherein the center of mass of the at least one weight attached to the first gear is positioned in-phase with the at least one weight attached to the second gear.

44. The massage device of claim 39, wherein the at least one weight of the first gear is attached to the first gear so that the at least one weight moves relative to the first gear while the at least one weight of the second gear remains substantially motionless relative to the second gear.

45. The massage device of claim 31, wherein the at least one oscillation device comprises at least one body rotatably about a shaft, the body including a slot for receiving a first cam and having at least one massage head coupled thereto, and the first cam positioned in the slot and mechanically coupled to the at least one water driven drive means.

46. The massage device of claim 45, further comprising a second cam pivotably coupled to the first cam for changing the action of the body depending on the direction of rotation of the at least one water driven drive means.

47. The massage device of claim 45, wherein the second cam is positioned relative to the first cam to change between a large oscillation pattern and a small oscillation pattern.

48. The massage device of claim 31, wherein the at least one water driven drive means is at least one impeller.

49. The massage device of claim 48, further comprising at least one valve coupled to at least one conduit for controlling fluid flowing through the at least one conduit and striking the at least one impeller.

50. The massage device of claim 49, wherein the at least one valve is adjustable between an off mode, an open mode allowing fluid to flow through a first outlet, and an open mode allowing fluid to flow through a second outlet, and further comprising at least one conduit coupled to the first outlet and having at least one end positioned proximate to the at least one impeller to expel a fluid to rotate the impeller in a first direction and comprising at least one conduit coupled to the second outlet and having at least one end positioned proximate to the at least one impeller to expel a fluid to rotate the impeller in a second direction that is generally opposite to the first direction.

51. The massage device of claim 50, wherein the at least one impeller comprises a first portion having a first diameter and a second portion having a second diameter that is greater than the first diameter, and wherein the at least one end of the at least one conduit coupled to the first outlet is positioned to expel a fluid from the end to rotate the at least one impeller in the first direction, and the at least one end of the at least one conduit coupled to the second outlet is positioned to expel a fluid from the end to rotate the at least one impeller in the second direction.

52. The massage device of claim 31, further comprising at least one additive emitting means for mixing a fluid with an additive.

53. The massage device of claim 52, further comprising at least one valve coupled to at least one conduit for directing fluid into the at least one additive emitting means; wherein fluid flow through the valve is adjustable along a continuum between a completely open mode and a completely closed mode.

54. The massage device of claim 31, further comprising at least one orifice in the at least one chamber for releasing a fluid from the head to contact a user.

55. The massage device of claim 31, wherein the head comprises at least one first chamber containing the at least one water driven drive means and at least one second chamber containing the at least one oscillation means.

56. The massage device of claim 55, wherein the at least one oscillation means is positioned in the second chamber, and further comprising a fluid barrier isolating the at least one oscillation device from the at least one chamber and wherein the fluid barrier substantially prevents the fluid from contacting the at least one oscillation device.

57. The massage device of claim 55, further comprising at least one drain positioned in the at least one first chamber for draining fluids.

58. The massage device of claim 55, further comprising at least one drain positioned in the at least one second chamber for draining fluids.

59. The massage device of claim 55, wherein the head is pivotably coupled to the handle.

60. The massage device of claim 59, further comprising at least one rotation limiting device for limiting a range of rotation of the head relative to the handle.

61. The massage device of claim 60, wherein the at least one rotation limiting device comprises at least one spring positioned between the handle and the head.

62. A method of generating a massaging action, comprising:
passing a fluid into a massage device to contact at least one impeller, wherein the massage device includes a head pivotably coupled to the handle, the head having at least one chamber and at least one massage head adapted to contact a skin surface of a user;
rotating the at least one impeller positioned in the head, which in turn rotates at least one oscillation device disposed in the head and coupled to the impeller for moving the head in an oscillatory motion relative to the handle, wherein the at least one oscillation device is substantially shielded from contact by the fluid emitted from the at least one fluid conduit;
oscillating the head and the at least one massage head coupled to the head relative to the handle;
contacting the at least one oscillating massage head with a skin surface of a user;
exhausting at least a portion of the fluid from the massage device proximate to the at least one massage head; and
enabling the fluid exhausted from the massage device to contact the skin surface of the user.

63. The method of claim 62, wherein passing a fluid into a massage device to contact one or more impellers further comprises receiving the flowing fluid from a shower head fitting in a shower.

64. The method of claim 62, wherein the fluid exhausted from the massage device is greater than about 75 degrees Fahrenheit.
